(19) United States
(12) Patent Application Publication
(10) Pub. No.: US 2014/0065511 A1
(43) Pub. Date: Mar. 6, 2014

(54) STRIPS FOR LINKING AN ELECTROCHEMICAL CONVERTER'S ANODES AND CATHODES AND CONVERTER COMPRISING SAME

(71) Applicants: Pierre Forte, Bayonne (FR); Catherine Lepiller, Ahetze (FR)

(72) Inventors: Pierre Forte, Bayonne (FR); Catherine Lepiller, Ahetze (FR)

(21) Appl. No.: 13/989,993

(22) PCT Filed: Apr. 7, 2011
(86) PCT No.: PCT/FR2011/050780

§ 371 Date: Oct. 4, 2013

(30) Foreign Application Priority Data
Apr. 8, 2010 (FR) 1052661

(51) Int. Cl. H01M 8/02

(52) U.S. Cl. CPC H01M 8/0245
USPC 429/468; 429/507

(57) ABSTRACT

A strip for linking anodes and cathodes of an electrochemical converter is made from a metallized porous substrate including a hydrophobic coating, at least in areas in contact with the anodes or cathodes.

### CROSS-REFERENCE TO RELATED APPLICATIONS

This application is the National Stage of International Application No. PCT/FR2011/050780 International Filing date, 7 Apr. 2011, which designated the United States of America, and which International Application was published under PCT Article 21(s) as WO Publication 2011/124850 A1 and which claims priority from, and the benefit of, French Application No. 1052661 filed on 8 Apr. 2010, the disclosures of which are incorporated herein by reference in their entireties.

### BACKGROUND

The disclosed embodiment concerns an improvement of a fuel cell type of electrochemical converter.

Document EP1 846 976 A1 describes an electrochemical converter with proton membrane comprising a plurality of electrochemical cells connected in series, which comprises a first substrate, in the form of a continuous tape and second substrates in the form of segments of tape, the first substrate comprising a first face on which a succession of first deposits is realized so as to form a series of spaced anodes, and a second face on which a succession of second deposits is realized so as to form a series of spaced cathodes arranged opposite said anodes, said anodes and cathodes forming a succession of electrochemical unitary cells, the first substrate being provided with a succession of feed-throughs for the second substrates, the second substrates being sized to produce a connection track between a cathode of one unitary cell and an anode of an adjacent unitary cell.

In this converter, the electrodes are positioned on a first substrate constituted by a proton membrane and connecting the electrodes in series is achieved by means of feed-throughs and second substrates going through the first substrate to make connection tracks between an anode and a cathode from adjacent cells.

The second substrates constitute gas diffusion layers, made in particular in a second substrate of metallized porous polymer fabric to make it conductive and thus produce the connection tracks between the unitary cells.

This makes it possible to produce a small-size electrochemical converter supplying a high voltage.

### SUMMARY

The disclosed embodiment relates to an improvement of such a converter for which the second substrates are made in the form of porous strips with a metallized polymer base and covered with a hydrophobic layer.

More specifically, the disclosed embodiment concerns a strip for linking an electrochemical converter's anodes and cathodes characterized in that it is realized from a metallized porous substrate comprising a hydrophobic coating, at least in areas in contact with said anodes and/or cathodes.

According to a first embodiment, the porous substrate is based on woven fabric.

According to a second embodiment, the porous substrate is based on nonwoven fabric.

According to the disclosed embodiment, the porous substrate comprises in particular a polymer base.

The polymer base is then advantageously chosen from a polyamide, polyester, aramid base or a combination of at least two of these materials.

According to a first alternative, the porous substrate is made of a polyester-based copolymer.

According to a second alternative, the porous substrate comprises a glass base.

The thickness of the substrate is advantageously between 100 and 600 μm.

Preferably, the thickness of the substrate is between 150 and 300 μm.

The density of the substrate is advantageously between 50 and 200 g/m2 and preferably between 60 and 120 g/m2.

According to the disclosed embodiment, metallization of the substrate is performed with a metal chosen from Cu, Au, Sn, Ni, NiP or their alloys.

Advantageously, the thickness of the metallization deposit is between 0.5 and 20 μm, preferably between 1 and 10 μm.

The surface density of metallization is advantageously between 25 and 300 g/m2 and preferably between 50 and 200 g/m2.

The hydrophobic coating of the strip advantageously comprises a thermoplastic polymer elastomer.

Said polymer preferably comprises vinyl functionality.

The polymer is advantageously chosen among poly(Styrene-Ethylene-Butadiene-Styrene) (SEBS), poly(Styrene-Butadiene-Styrene) (SBS), poly(Styrene-Ethylene-Propylene-Styrene) (SEPS), homopolymer poly(butadiene)hydroxy (PBu), poly(Butadiene-Octene) (PBO), poly(Ethylene-Octene) (PEO), poly(Butadiene-Propylene) (PBP), poly(Vinylidene Difluoride) (PVDF), the poly(Vinylidene Difluoride (PVDF)-HexaFluoroPropylene (HFP)) copolymer or poly(vinylidene difluoride-co-trifluoroethylene) (PVDF-TrFE).

Said polymer is preferably maleic anhydride grafted poly(Styrene-Ethylene-Butadiene-Styrene) (SEBS).

The hydrophobic coating advantageously comprises a porous conductive material.

The porous conductive material is preferably chosen from carbon black nanopowders, carbon nanofibers and carbon nanotubes.

The hydrophobic coating advantageously comprises a polymer and the polymer/carbon ratio is between 10/90 and 50/50.

The polymer/carbon ratio is preferably between 20/80 and 30/70.

The strip of the disclosed embodiment then has a polymer/carbon loading of between 0.5 and 50% by mass.

Said loading is preferably between 10 and 50%.

In addition, the disclosed embodiment concerns an electrochemical converter comprising a tape carrying unitary cells characterized in that it comprises second substrates in the form of strips according to any one of the preceding claims realizing connection tracks going through the carrier tape to link anodes of one cell to cathodes of adjacent cells.

The strips advantageously go through the carrier tape via feed-through slots, an adhesive or a thermoplastic adhesive film closing the slots so as to be impermeable to gases.

The adhesive advantageously comprises a temperature- or ultraviolet-polymerizing resin.

The resin is preferably a solvent-free resin chosen from the family of silicones, acrylates, urethane acrylates, modified epoxies.

The adhesive's viscosity is advantageously chosen depending on the thickness of the strip and the fiber density of the porous material.

In particular, the adhesive's viscosity is advantageously between 0.3 and 50 Pa s.

The chosen glue or adhesive is in particular designed to impregnate the connection track in its depth without reducing the electronic conductivity.

According to a variant of the disclosed embodiment, a thermoplastic adhesive film closes the slots so as to be impermeable to gases. The film is chosen from the family of modified polyolefins, polyesters, polyamides or polyether amides.

The width of the adhesive film is advantageously between 2 and 10 mm and preferably between 2 and 5 mm, with its thickness being between 50 and 300 μm.

Lastly, the disclosed embodiment concerns a method of producing strips for linking an electrochemical converter's anodes and cathodes characterized in that

a porous substrate according to the disclosed embodiment is chosen,

a step of metallizing the substrate is performed with a metal chosen from Cu, Au, Sn, Ni, NiP and/or their alloys, which step comprises one or several surface preparations of the strips' substrate followed by steps in a solution including at least one chemical deposition on the isolating fibers with Cu or NiP and one or several galvanostatic depositions.

The metallization step is advantageously derived from the autocatalytic path, completed by continuous mechanical stirring.

Preferably, the metallization continues until a total deposit thickness around the metallized fibers of between 0.5 and 20 μm, preferably between 1 and 10 μm, is achieved.

According to the disclosed embodiment, the metallized strip is subjected to a low-temperature hydrophobic treatment by coating or pulverization utilizing polymers usable in solution or emulsion, hydrophobic in nature and whose permeability is compatible with the passage of the reactant gases through the formed layer.

Said polymer advantageously belongs to the thermoplastic elastomers class.

Said polymer preferably has vinyl functionality.

Advantageously, to subject the strip to the hydrophobic treatment, a so-called polymer sintering operation is performed.

Advantageously, to subject the strip to the hydrophobic treatment, the polymer is dissolved at least partially in a solvent or in a mixture of solvents so as to obtain a colloidal solution or suspension.

According to a particular embodiment, to subject the strip to the hydrophobic treatment, an aqueous latex suspension type of formulation is used.

Preferably, the solutionization is performed by magnetic or mechanical stirring at a temperature between the ambient temperature and 80° C.

Advantageously, the hydrophobic treatment is performed by free coating.

After coating, the solvent(s) is/are removed and a sintering operation is performed in a drying oven at a temperature higher than the transition temperature of the hydrophobic polymer and slightly lower than its fusion point.

The sintering duration is in particular between 30 minutes and 2 hours.

The hydrophobic treatment by coating advantageously includes a porous conductive material whose pore size distribution is centered around a value below 1 μm.

The porous conductive material is preferably chosen from carbon black-type nanopowders, carbon nanofibers and carbon nanotubes.

The porous conductive material is advantageously added to the hydrophobic polymer dispersion in a polymer/carbon ratio of between 10/90 and 50/50, preferably between 20/80 and 30/70.

### BRIEF DESCRIPTION OF THE DRAWINGS

Other features and advantages of the disclosed embodiment will become apparent in reading the following description of a non-limiting example of realization of the disclosed embodiment with drawings, which show:

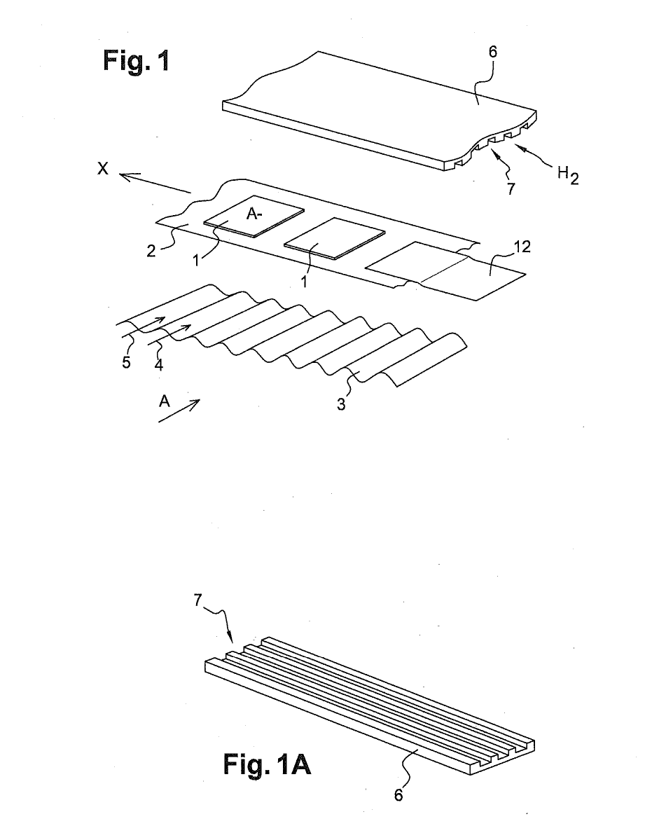

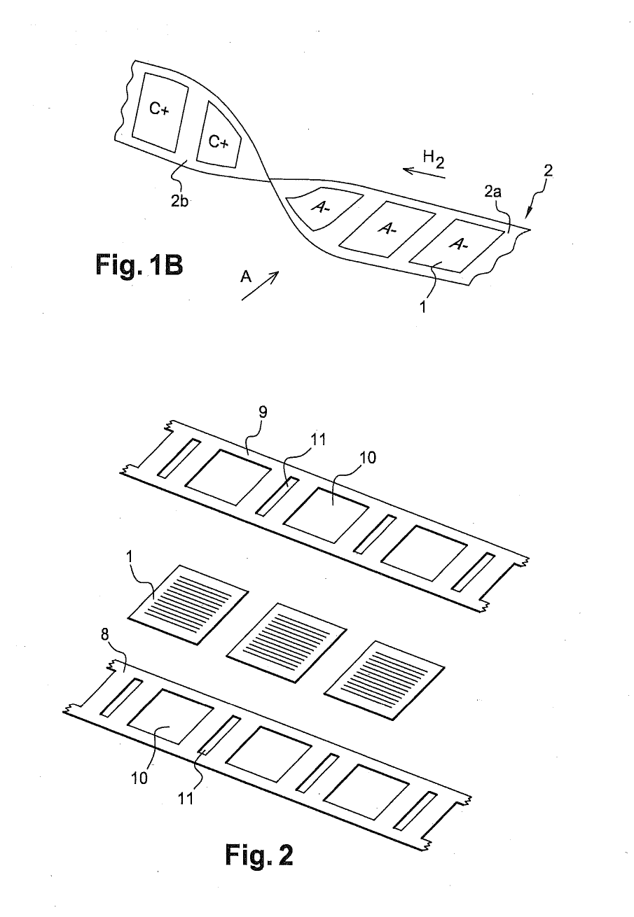

in FIG. 1: a perspective view of a detail of an example of realization of a converter according to the disclosed embodiment;

in FIG. 1A: a perspective view from below of a covering designed to supply hydrogen to the converter of FIG. 1;

in FIG. 1B: a perspective view of the tape in FIG. 1, twisted;

in FIG. 2: an exploded view of a support tape for cells of the disclosed embodiment according to a first assembly step;

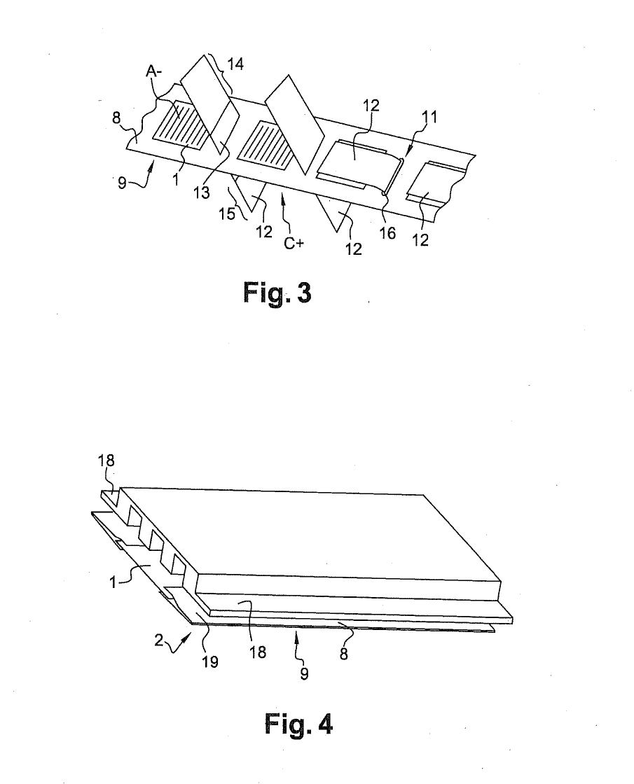

in FIG. 3: a perspective view of the support tape of FIG. 2 according to a second assembly step;

in FIG. 4: a perspective view of a step of fitting the tape of FIG. 3 with a covering according to FIG. 2;

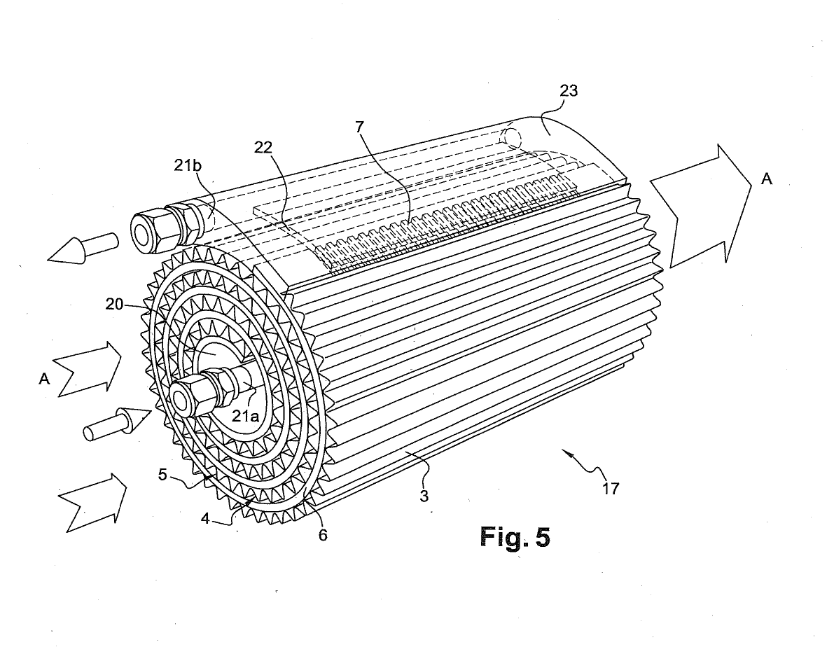

in FIG. 5: a perspective view of a cylindrical converter according to the disclosed embodiment.

### DETAILED DESCRIPTION

FIG. 1 represents a proton-membrane electrochemical converter element realized according to the disclosed embodiment, which comprises a plurality of electrochemical unitary cells 1 connected in series and arranged on a carrier tape 2 elongated along a longitudinal axis.

As represented in FIG. 1B, where the tape 2 has been twisted so as to show its top and bottom, a first face 2a of the tape has anodes A− and receives hydrogen H2 and a second face 2b of the tape has cathodes C+ and receives air A.

The hydrogen circulates in a flow parallel to the longitudinal axis X of the tape 2 and the air circulates in a flow transverse to the longitudinal axis of the tape.

According to the disclosed embodiment, separation means, identified as 3 in FIG. 1, divide the air flow into two parts, namely a cooling flow 4 having no contact with the cathodes and a cathodic reaction flow 5 in contact with the cathodes C+.

These separation means 3 are made, according to the example, of a corrugated film, the corrugations of which are arranged perpendicular to the longitudinal axis X of the tape.

It should be noted that the cathodic reaction flow plays a role in the cooling.

Thus, the partial flows 4 and 5 play a role in the cooling, whereas the flow 5 plays a role in the cathodic reaction.

This allows the cooling of the fuel cell to be improved without increasing the cathodic air flow too much, which might cause problems of drying-out of the electrolyte through over-ventilation.

The separation means of the disclosed embodiment allows the ratio (reaction air flow rate)/(cooling air flow rate) to be varied by varying the geometry of the corrugated tape, e.g. by realizing asymmetric corrugations making one passing section larger on one side than the other.

The advantage of using a corrugated film is its simplicity of utilization, because the corrugations naturally form means of separating layers when layers of cells are stacked or when the tape bearing the cells is wound up, as in this realization.

The corrugated film may, in particular, be made from a PET plastic with a thickness of the order of ¼ mm or between ⅕ and ⅓ mm.

The corrugations or flutes are heat-formed by passing the film through a forming tool.

The corrugations are designed to withstand crushing when layers or windings are made to produce a complete converter.

On the anodes side, the carrier tape is covered by an elastomer covering 6 provided with longitudinal channels 7 for the passage of hydrogen.

The elastomer covering has a thickness of the order of 1 mm, e.g. between 0.8 and 1.2 mm.

The longitudinal channels are in the form of grooves of 0.5 to 2 mm wide and 0.5 to 1 mm deep.

This elastomer covering, of a width equivalent to the width of the tape bearing the unitary cells, is made from a material such as a silicone, EPDM, polyisobutylene, polyethylene acrylic or chlorosulfonated polyethylene, and is fixed hermetically on the edges of the tape by gluing or hot lamination to form a channeling means in which the hydrogen circulates.

FIG. 4 gives an example of realization where the covering is provided with lateral wings 18 intended to be glued onto the edges 19 of the tape comprising the cells 1 and formed by the gluing of bands 8 and 9.

The tape is, according to the example of FIG. 2, made from two bands 8, 9 punched or cut out to form a succession of windows 10 retaining unitary cells 1 and provided with slots 11 for the passage of strips 12 forming gas diffusion layers and electrical connections between successive anodes and cathodes.

The thickness of the finished tape is in a range of 50 to 150 μm, the bands being made from an insulating thermoplastic material and in particular a thermoplastic polymer impermeable to gases.

The bands are assembled one on top of the other so as to enclose the unitary cells 1, in a manner similar to the frames known, for example, from document US2004/0112532 A1.

In order to connect the unitary cells in series it is necessary to traverse the tape, the anodes and cathodes being on opposite sides of it.

Connection means are used, which are realized from a substrate made in the form of a porous metallized strip and coated with a hydrophobic coating, at least in areas in contact with said anodes and/or cathodes.

The strips can be based on woven material or based on nonwoven material designed to allow the reactant gases to pass through to the cells' electrodes.

They can in particular be made from technical fabrics from the fields of filtration, hygiene and protection, aeronautics or the automobile industry.

In cases where the strips are realized with nonwovens, the latter can be needle felts, hydroentangled nonwovens (spunlace) or according to the method known as spunbond.

The micro-filaments making up the nonwovens are obtained by wet- or dry-laid process. An additional calendering step may be provided or not. Wet-laid and calendering are preferred.

The structure of the selected wovens or nonwovens is anisotropic, i.e. essentially a two-dimensional structure wherein the fibers are aligned in a more-or-less ordered fashion in the textile's plane. In this way, after metallization, the electrical connections between the fibers will preferably be established in this plane. This property is sought after for the envisaged application, because the preferred conduction path will occur from one cell to another within the plane of the metallized connection track.

The strips' fibers are selected from polyester, polyamide, aramid and glass fibers; they can also be formed from a polyester-base copolymer or from a mixture of these fibers.

The base component is preferably polyester. These various fibers all have a good level of mechanical resilience while remaining flexible, which is an essential criterion for the application sought in a wound device.

Their temperature resilience is up to a continuous 120° C., preferably 160° C. and ideally 180° C.

As regards the substrates' geometry, the selection criteria are: thickness, between 100 and 600 μm, preferably between 150 and 300 μm; total porosity (vacuum ratio), which must be above 60%, preferably between 65 and 85%; and air permeability, which must be between 50 and 5000 L/m²s at a pressure of 200 Pa, preferably between 80 and 3800 L/m²s.

The surface density of the synthetic polymer is between 50 and 200 g/m² and preferably between 60 and 120 g/m². In particular, a high volumetric fiber density is sought, which is able to provide a connection track with high electrical conductivity after metallization of the fibers.

The diameter of the synthetic fibers can vary from 5 to 50 μm, preferably from 7 to 30 μm. Their length may vary up to infinity (mono-filament or continuous filament principles).

FIG. 3 illustrates the placing of the strips 12, which are inserted into the slots 11 and then applied on the electrodes on and under the tape.

The strips 12 pass from one side of the tape to the other at the feed-through slots 11.

To complete the assembly of the strips, an adhesive or a thermoplastic adhesive film 16 closes the slots so as to be impermeable to gases.

For this, for example, a temperature and/or ultraviolet polymerizing resin or a thermoplastic adhesive film is used.

The assembly must remain flexible after gluing to allow the tape to be wound in a spiral.

The solvent-free type of resins used can be silicones, acrylates, urethanes or modified epoxy resins.

Silicone or epoxy resins are preferred because of their greater resistance to the acidity and humidity conditions of this application.

In order to fill the fabric of the strips, allow speedy gluing and obtain a good level of adherence, the viscosity of the resins can be between 0.3 and 50 Pa·s., the optimum viscosity depending on the thickness and density of the strips' fibers.

In the case where a thermoplastic film is used, this can be chosen from among the family of modified polyolefins, polyesters, polyamides or polyether amides.

It can be applied under pressure and/or hot-applied.

The strips 12 making these feed-throughs have a dual function, letting the gases pass to the electrodes and conducting the current from one electrode to another.

As seen above, the strips are made from a polymer material, woven or not.

The intrinsic characteristics of this material are chosen according to its dual role as connection track and gas diffusion layer in a fuel cell, i.e. a fiber density ensuring a good compromise between high gas permeability and high electrical conductivity after a step of metallizing the material.

For electrical conductivity, the strips 12 are metallized so as to provide the connection between their areas 14, 15 of contact with the anodes and cathodes.

The metals that can be used are, more specifically: Cu, Au, Sn, Ni, NiP and/or their alloys.

These metals are deposited chemically or electrochemically.

A last deposition step can be performed by a physico-chemical technique in vapor phase or under vacuum.

The metallization method comprises: one or several surface preparations of the strips' substrate followed by steps in a solution including at least one chemical deposition on the isolating fibers with Cu or NiP and one or several galvanostatic depositions. The deposition method is derived from the standard autocatalytic process, which allows uniform and homogenous deposition over large surfaces and varied geometries. Continuous mechanical stirring during synthesis is added, which aims to metallize the fibers individually.

An example of a usable method is described in patent US 2004/0013812 A1.

Such a dynamic metallization method eliminates the formation of metal nodes at the intersections of fibers, as is the case in a conventional static electrolytic bath. It also makes metallization in the entire thickness of the textile possible.

The total thickness of the metallization deposit is between 0.5 and 20 μm, preferably between 1 and 10 μm.

The surface density is between 25 and 300 g/m² and preferably between 50 and 200 g/m².

Together with the large volumetric fiber density of the selected substrates, the individual and three-dimensional covering of the fibers makes it possible to increase the electronic conduction paths in the plane of the substrate and to achieve conductivity values compatible with the envisaged application: 5×102-104 S/cm, preferably 103-105 S/cm.

The values measured in the metallized textile's plane vary according to the type of metal deposit: thus, for example, copper is a better conductor than nickel. Its volumetric conductivity is 5.8×105 S/cm (Cu) whereas that of nickel is 1.46×105 S/cm. Gold has an intermediate value: 4.4×105 S/cm.

Electronic conductivity increases in step with the thickness of the deposit and also reflects the quality of adhesion on the polymer substrate, which can vary depending on its type and structure.

The initial surface treatment steps as well as the sublayer are optimized so as to increase the affinity between the polymer and the solution and consequently improve the adhesion force of the deposited metal layer.

By comparison, the electronic conductivity in the carbon fiber gas diffusion layers' plane used in the stacks is of the order of 102 S/cm; this value is approximately an order of magnitude lower than the conductivity required for the envisaged application as a connection track in a spiral-wound fuel cell geometry.

The various metals constituting the outer metal layer, Au, Sn or NiP, have good anticorrosion properties to withstand the oxidizing conditions at the cathode; they are not oxidized and/or dissolved much in the high acidity and high relative humidity of the fuel cell.

In particular, gold is very stable in such media and can advantageously be deposited as a fine layer to cover the main NiP deposit, for example. Its high level of malleability also makes it best choice of metal, at least as an outer deposit, to preserve the integrity and resilience of a deposit constituting a flexible connection track.

A thin outer layer of gold can be deposited preferably using a physical technique in a vacuum (PVD) or a chemical technique in vapor phase (CVD).

The strips then receive a hydrophobic treatment.

Using a metallized polymer textile as flexible connection track and gas diffusion layer for fuel cells makes an additional chemical treatment of the raw substrate necessary. This treatment is applied in the mass and/or the surface; it is intended to give the substrate partially hydrophobic properties that will allow the water generated by the fuel cell in operation to be evacuated to the exterior by the double gas distribution tape.

In conventional fuel cell stacks, the carbon fiber gas diffusion layers are treated in the mass with a polytetrafluoroethylene (PTFE) solution or emulsion.

Optionally, they may also be covered by pulverization over one or two sides with a nanoporous carbon and PTFE based microporous layer as described for example in document U.S. Pat. No. 6,277,513 B1 so as to improve the control of water in the core of the fuel cell and to optimize the electrical and fluidic contact between the electrodes and the gas diffusion layer.

These treatments require a step of sintering of the PTFE at about 340° C., which is prohibited in the context of the disclosed embodiment because of the use of a synthetic polymer.

A low-temperature hydrophobic treatment is required here; this treatment can be performed by coating or pulverization.

This treatment may possibly utilize alternative polymers usable in solution or emulsion, hydrophobic in nature and whose permeability is compatible with the passage of the reactant gases through the formed layer.

The properties of Teflon serve as the reference for permeability and hydrophobia.

The coating formed must provide a good level of adhesion and a good level of mechanical resilience once its base has been metallized, then, after winding, be chemically compatible with the fuel cell's environment (low-acidity environment, heat cycles, etc.) Lastly, it must be able to be deposited and to reach its final characteristics at a low temperature <180° C.

The selected polymer preferably belongs to the thermoplastic elastomers class, which gives it the flexibility required by the application. Preferably it has vinyl functionality.

A so-called polymer sintering operation is performed so that the polymer can spread and evenly cover the fibers of a hydrophobic gas-permeable layer.

This operation consists of bringing the polymer up to a so-called sintering temperature, i.e. a temperature that is between the polymer's glass transition temperature and its fusion temperature and in the vicinity of the latter.

Within the context of the disclosed embodiment, this temperature is preferably between 80 and 180° C., ideally between 100 and 160° C.

The polymers typically selected are hydrophobic elastomers with aromatic vinyl functionality such as block copolymers such as poly(Styrene-Ethylene-Butadiene-Styrene) (SEBS), poly(Styrene-Butadiene-Styrene) (SBS) or poly(Styrene Ethylene-Propylene Styrene) (SEPS), simple hydrophobic elastomers with vinyl functionality such as homopolymer poly(butadiene)hydroxy (PBu), copolymers such as poly(Butadiene-Octene) (PBO), poly(Ethylene-Octene) (PEO), or poly(Butadiene-Propylene) (PBP), or even thermoplastic fluoropolymers with vinyl functionality such as poly(Vinylidene Difluoride) (PVDF), the poly(Vinylidene Difluoride (PVDF)-HexaFluoroPropylene (HFP)) copolymer or poly(vinylidene difluoride-co-trifluoroethylene) (PVDF-TrFE).

Some grades can advantageously be grafted so as to, firstly, reinforce the adhesion properties of the polymer on the metallized substrate and secondly, increase the polymer's polarity, which facilitates its solutionization. The grafting rate is between 0.01 and 2.0% and preferably between 0.05 and 1.7%.

The preferred polymer is the SEBS elastomer and the preferred grade is maleic anhydride grafted SEBS known by the trademark Kraton FG 1901X. Another preferred polymer is the PVDF-HFP copolymer and the preferred grades are known under the trademarks Kynar ADXFlex 2000, Superflex 2500 and Latex RC-10.206.

In the case of elastomers with aromatic vinyl functionality, the appropriate solvent is in particular chosen among aromatic hydrocarbons such as toluene, but for grades with low polarity because of grafting, it can advantageously be chosen among esters, ethers and ketones. Low-cost, low toxicity solvents are preferred.

Within the acetates family (esters) our selection includes n-butyl acetate, isobutyl acetate, n-Propyl acetate and isopropyl acetate. Because it is non-toxic and low-cost, n-butyl acetate is preferred. Within the ethers family, our selection includes dimethoxymethane, methyl tert-butyl ether (MTBE) and tetrahydrofuran (THF). Because of their low environmental impact, the first two solvents are preferred. Within the ketones family, our selection includes 3-pentanone, methyl isobutyl ketone (MIBK) and methyl ethyl ketone (MEK). Another possible fluoropolymer solvent is for example n-methylpyrrolidinone (NMP). A mixture of several solvents can also be used, which may or may not include a solvent different from the list above, depending on the dissolving properties sought.

The polymer can be completely or partially dissolved in the solvent or in the mixture of solvents; a colloidal solution or suspension is then obtained. The type of the mixture, solution or colloidal suspension, depends upon the interactions between the polymer chains and the solvent molecules. An aqueous latex suspension type of formulation can also be used. The solutionization is performed by magnetic or mechanical stirring at a temperature between the ambient temperature and 80° C.

The concentration of the solution by mass is between 1 and 20% and preferably between 2 and 10%.

The hydrophobic treatment is preferably performed at a temperature below 80° C., below 50° C. if possible, and ideally at ambient temperature if the hydrophobic polymer's solubility is sufficiently high under these conditions.

The hydrophobic treatment can be performed by free coating (dipping), painting or pulverization. To ensure better impregnation of the metallized fibers in the depth, the free coating method is preferred. One to six dippings can be necessary to obtain the optimum hydrophobic properties, preferably one to three. Ideally, one or two dippings are sufficient.

After coating, the metallized connection tracks are ventilated under a hood or dried in a vacuum if the boiling point of the solvent or of the mixture of solvents is high. They are then sintered in a drying oven at a temperature higher than the transition temperature of the hydrophobic polymer and slightly lower than its fusion point. The sintering duration is between 30 minutes and 2 hours and preferably 1 hour. The sintering step can be performed after each coating or at the end of the various coatings required to obtain optimum hydrophobic properties.

Following the hydrophobic coating treatment, the metallized substrate has a polymer loading of between 0.5 and 50% by mass. The optimum loading is between 1 and 20%.

Following this treatment, the electrical conductivity in the plane is not changed by more than 10% from its initial value, ideally 5%, because the thickness of the polymer coating is relatively small and the coating is not continuous over all the metallized fibers. The polymer preferably covers the intersections of the fibers and the layer is very fine or partial on the fibers themselves. Some areas, in particular at the heart of the textile, are without this deposit, which makes it possible to preserve the electrical conductivity as well as a mixed hydrophilic/hydrophobic type of surface tension compatible with the envisaged application as a gas diffusion layer in a fuel cell.

Alternatively, the hydrophobic treatment by coating can include a porous conductive material that makes it possible to maintain the metallized fabric's conductivity and to add a network of smaller-sized porosities within its structure. This additional porosity, whose size distribution centers around a value below 1 μm and preferably between 0.1 and 0.5 μm, aims to modify favorably the evacuation scheme of the water generated in the fuel cell. Because of its high corrosion resistance, the wide variety of microstructures available and its availability on the market, carbon is the best choice of material.

Carbon black-type nanopowders, carbon nanofibers and carbon nanotubes are used. These products are added to the hydrophobic polymer dispersion in a polymer/carbon ratio of between 10/90 and 50/50, preferably between 20/80 and 30/70. The concentration of the dipping solution by mass is between 2 and 20%; ideally, it is between 5 and 10% by mass.

Following the alternative hydrophobic coating treatment, the metallized substrate has a polymer/carbon loading of between 0.5 and 50% by mass. The optimum loading is between 10 and 50%. According to this free coating method, both sides of the substrates are covered by the microporous mixture consisting of carbon black and hydrophobic polymer. The substrate is more or less impregnated in its thickness, depending on its absorbent properties in regards of the coating solution as well as its viscosity.

The treatment of the metallized textile can be realized in two steps or comprise only one of the two steps described earlier.

If the treatment is realized in two steps, a first treatment is then a treatment by coating with a hydrophobic polymer solution or dispersion alone.

At the end of this first treatment, before or after the step of sintering the polymer, a mixture of hydrophobic polymer and carbon is deposited at the surface of one of the two sides of the textile and forms a microporous layer.

This layer is used both to improve the quality of the electrical interface between the electrodes and the connection track, therefore to reduce ohmic loss within the fuel cell, and to improve the control of the water expelled while it is in operation.

The mixture of hydrophobic polymer and carbon deposited on the surface, thanks to the nanometer-scale size distribution of its pores, between 100 and 500 nm, forms a partial barrier to the passage of water generated at the cathode and encourages its diffusion towards the anode through the proton membrane. This process improves the membrane's humidification rate and increases its ionic conductivity, which reduces ohmic losses in the system.

Given the spiral-wound geometry of the fuel cell described in the disclosed embodiment, only those surfaces facing the cathodes and/or anodes or both sides of the metallized substrates can be coated with a microporous layer by this second treatment because the depositions are consecutive and independent.

The polymer used in the microporous layer of the second treatment is selected from the previous list. It can be the same as or different from the hydrophobic polymer used in the coating step. The carbon used can be made of carbon black-type nanopowders or acetylene black, carbon nanofibers or nanotubes. The composition of the polymer/carbon mixture is typically a mass ratio of between 20/80 and 30/70. The polymer is dissolved beforehand, before mixing with the carbon black.

The mixture is preferably obtained in the form of an ink, i.e. a relatively high viscosity emulsion, wherein the carbon nanoparticles and the molecules of polymer are highly dispersed in the medium.

The solvent used is preferably a mixture of two or of several solvents that can be mixed with one another, but have different dielectric constants: at least one of them is a solvent suited to the hydrophobic polymer and the other can be less effective.

The first solvent is selected from the list of solvents previously described and the second solvent(s) is (are) preferably selected from the family of alcohols, such as ethanol or isopropanol for example.

The volumetric composition of the solvent mixture can vary in any proportions compatible with total miscibility and its ability to allow an emulsion to be obtained from the two constituting elements, the hydrophobic polymer and the nanoporous carbon.

One of these solvents can have an additional role of stabilizing the suspension by upholding the interaction forces of the various elements. It can also improve the ink's texture and binding agent, as well as its ability to cover the substrate evenly.

This solvent or additive is preferably selected from the family of polyalcohols. It can be glycerol or propylene glycol, for example. A small quantity thereof is added when the ink is formulated: its percentage by mass in the solvent can vary from 0 to 10%; typically it is a few %.

The emulsion is obtained preferably by the ultrasound method or by high-shear mechanical mixing of the initial solution. The procedure is performed at ambient temperature. Its duration can vary from 30 minutes to several hours, depending on the mixing method and parameters, such as the frequency of the ultrasounds and the rotation speed of the motor.

The ink is then deposited by manual pulverization or by any other automatic or semi-automatic method of thin film deposition from ink; among these, serigraphic, pulverization and inkjet techniques can be cited.

The various automatic methods using successive rollers can be used advantageously because of the flexibility of the connection tracks to be treated and of the continuous manufacturing process sought for implementing the fuel cell.

Deposition is followed by a step of sintering in a drying oven at a temperature higher than the transition temperature of the hydrophobic polymer and slightly lower than its fusion point. A microporous layer is formed at the surface of the textile and penetrates partially into the textile's thickness. The penetration rate depends on the viscosity of the mixture and on the quantity deposited.

The final thickness of the microporous layer is between 10 and 100 μm.

Thanks to the elastic properties of the selected hydrophobic polymers and to their excellent adhesion to the metallized connection track, the latter's flexibility is not significantly altered at the end of the hydrophobic treatment or treatments and spiral-winding according to the initial principle is possible.

Similarly, the use of carbon and the realization of thin films does not alter the electrical conductivity of the connection track. As a result, this treatment makes it possible to add the ability to efficiently evacuate the water generated by the fuel cell to the electronic conduction and gas transfer properties. It also allows the electrical interfaces to be optimized. The assembly obtained is simultaneously a connection track and a gas diffusion layer for spiral-wound geometry fuel cells.

FIG. 5 is a schematic of an electrochemical converter in a spiral, which comprises a tape bearing electrochemical unitary cells, wherein strips link the successive anodes and cathodes so that the cells are connected in series, an elastomer covering 6 provided with passages 7 in a longitudinal direction of the tape on a side of the tape provided with anodes, a corrugated film 3 on the side of the tape bearing the cathodes, whose corrugations are aligned transversally to the tape 2, said tape, said covering 6 and said film 3 being wound in a spiral so as to form a compact cylindrical electrochemical converter 17.

The air supply A of the converter occurs in a direction parallel to the axis of the cylinder, the corrugated film forming a barrier separating the cooling air 4 and the air supplying the cathodes 5.

The hydrogen circuit H2 is realized from input 21a and output 21b tubes, these tubes being connected to the passages 7 by ducts 22 linking a slot made in the tube and the extremity of the covering 6.

The hydrogen output tube, the flat output duct and the end of the covering are covered by a cover 23, for example realized with a resin or an impermeable composite material.

On the side of the hydrogen input in the axis of the cylinder formed by the wound fuel cell, the connection of the tube 21a can be performed by a flexible duct, the central space of the fuel cell possibly being filled with a filler material. To manufacture such a converter, the cells are assembled on the carrier tape, for example as seen above, by trapping the cells between two bands provided with windows, in a first step the strips are inserted into the tape at the slots made in the latter and they are applied onto the faces of the cells.

Then, the strips must be glued and the slots closed again.

An impermeable and flexible gluing must be realized at the connection track's feed-through between two successive membrane-electrode assemblies so as not to mix the reactant gases air and hydrogen.

The expected level of impermeability is a maximum hydrogen leakage of 100 ppm on the air side, preferably below 50 ppm.

A gluing method using a temperature and/or ultraviolet polymerizing resin or a thermoplastic adhesive film is provided.

The chosen glue or adhesive must impregnate the connection track in its depth without reducing the electronic conductivity. The assembly must remain fairly flexible after gluing to allow the tape to be wound in a spiral.

The solvent-free resin may be chosen from the family of silicones, acrylates, urethane acrylates, modified epoxies.

Because of their higher resilience to acidity, relative humidity and heat conditions, epoxy and silicone types of adhesives are preferred. Their viscosity is typically of between 0.3 and 50 Pa s, the adhesive's optimum viscosity depending on the thickness of the strip and the fiber density of the porous material. Their shore hardness D is between 25 and 90 and preferably between 30 and 70.

In all cases the adhesive's reticulation time does not exceed 60 s. Preferably, an increase in temperature is not required. The quantity of adhesive deposited is optimized so as to ensure total impermeability of the feed-through. The mode of deposition can be manual, e.g. by means of a fine syringe, automatic or semi-automatic, e.g. by means of a robot, by contact or projection. It is possible to deposit a single strand on one side of the fuel cell cores' tape, or to deposit two strands, one on each side, simultaneously in automatic mode, or successively in manual or semi-automatic mode.

The width of the strand is between 1 and 5 mm and preferably between 1 and 2 mm. Its height is between 0.1 and 1 mm and preferably between 0.1 and 0.5 mm.

If a thermoplastic adhesive film is used, this can be chosen from the family of modified polyolefins, polyesters, polyamides or polyether amides. It can be applied under pressure and/or hot-applied. One or two tapes of adhesive film can be applied at the feed-through.

The width of the adhesive tape is between 2 and 10 mm and preferably between 2 and 5 mm. Its thickness may be between 50 and 300 μm. The temperature of the process is between 110 and 150° C. and the pressure applied between 10 and 100 psi.

Impermeability between the side receiving the anodes and the side receiving the cathodes is realized by performing the gluing along the feed-through on one side or on both sides, taking into account the impregnation properties of the adhesive or resin used and the selected conditions of application.

Next, the covering 6 is applied onto the tape on the anodes side, the corrugated film is placed on the side of the elastomer covering opposite the longitudinal channels and then the tape covered by the covering and corrugated film is wound about itself or on a mandrel 20 such that one face of the corrugated film comes into contact with the face of the tape bearing the cathodes.

Winding the fuel cell about itself provides a certain compactness and offers a more favorable form factor for integration into a system.

In addition, winding the fuel cell about itself encourages thermal uniformity between the different cells, the heat generated by the electrochemical reaction on the cathode side spreading from one cell to another by contact between the various strata of the coil formed.

To finish the converter, the end cells of the tape are electrically connected to output contacts, a hydrogen supply end-fitting is placed on the termination of the longitudinal channels 7 outside the windings, a hydrogen recovery end-fitting is placed at the central axis or mandrel 20 of the converter, which is placed in a tube whose extremities serve as air inlet and outlet respectively.

1. A strip for linking an electrochemical converter's anodes and cathodes, the strip comprising:
a metallized flexible porous substrate covered in a hydrophobic coating, at least in areas in contact with at least one of said anodes or cathodes,
the porous substrate comprising a polymer base and the hydrophobic coating comprising a thermoplastic polymer elastomer comprising vinyl functionality and a porous conductive material.

2. The strip according to claim 1, wherein the porous substrate comprises woven or nonwoven fabric.

3. (canceled)

4. The strip according to claim 1, wherein the polymer base is chosen from at least one of a polyamide, polyester, or aramid base.

5. (canceled)

6. The strip according to claim 1, wherein a thickness of the substrate is between 100 and 600 μm.

7. (canceled)

8. The strip according to claim 1, wherein a density of the substrate is between 50 and 200 g/m².

9. (canceled)

10. The strip according to claim 1, wherein metallization of the substrate is performed with Cu, Au, Sn, Ni, or NiP or an alloy of Cu, Au, Sn, Ni, or NiP.

11. The strip according to claim 6 having a metallization deposit with a thickness between 0.5 and 20 μm.

12. (canceled)

13. The strip according to claim 6 having a surface density of metallization between 25 and 300 g/m².

14. (canceled)

15. The strip according to claim 1, wherein the material of the hydrophobic coating is a material that deposits at a temperature below 180° C.

16. The strip according to claim 1, wherein the polymer of the hydrophobic coating is chosen among poly(Styrene-Ethylene-Butadiene-Styrene) (SEBS), poly(Styrene-Butadiene-Styrene) (SBS), poly(Styrene-Ethylene-Propylene-Styrene) (SEPS), homopolymer poly(butadiene)hydroxy (PBu), poly(Butadiene-Octene) (PBO), poly(Ethylene-Octene) (PEO), poly(Butadiene-Propylene) (PBP), poly(Vinylidene Difluoride) (PVDF), the poly(Vinylidene Difluoride (PVDF)-HexaFluoroPropylene (HFP)) copolymer or poly(vinylidene difluoride-co-trifluoroethylene) (PVDF-TrFE) or maleic anhydride grafted poly(Styrene-Ethylene-Butadiene-Styrene) (SEBS).

17. The strip according to claim 1, wherein the porous conductive material is chosen from carbon black nanopowders, carbon nanofibers and carbon nanotubes.

18. The strip according to claim 11 wherein the polymer/carbon ratio is between 10/90 and 50/50.

19. (canceled)

20. The strip according to claim 11, having a polymer/carbon loading of between 5 and 50% by mass.

21. An electrochemical converter comprising:
a carrier tape carrying unitary cells;
second substrates in the form of strips for linking anodes and cathodes of the electrochemical converter, the second substrates comprising:
a metallized flexible porous substrate covered in a hydrophobic coating, at least in areas in contact with said anodes or cathodes,
the porous substrate comprising a polymer base and the hydrophobic coating comprising a thermoplastic polymer elastomer comprising vinyl functionality and a porous conductive material forming connection tracks going through the carrier tape to link anodes of one cell to cathodes of adjacent cells.

22. The electrochemical converter according to claim 21, wherein the strips extend through the carrier tape via feed-through slots, an adhesive or a thermoplastic adhesive film closing the slots so as to be impermeable to gases.

23. The electrochemical converter according to claim 22, wherein the adhesive comprises a temperature- or ultraviolet-polymerizing resin.

24. The electrochemical converter according to claim 23, wherein the resin is a solvent-free resin chosen from the family of silicones, acrylates, urethane acrylates, modified epoxies.

25. The electrochemical converter according to claim 22, wherein the adhesive's viscosity is chosen depending on the thickness of the strip and the fiber density of the porous material.

26. The electrochemical converter according to claim 25, wherein the adhesive's viscosity is between 0.3 and 50 Pa s.

27. The electrochemical converter according to claim 22, wherein the adhesive is designed to impregnate the connection track in its depth without reducing electronic conductivity.

28. The electrochemical converter according to claim 22, wherein the thermoplastic adhesive film closing the slots in a manner impermeable to gases is chosen from the family of modified polyolefins, polyesters, polyamides or polyether amides.

29. The electrochemical converter according to claim 22, wherein a width of the adhesive film is between 2 and 10 mm and a thickness of the adhesive film is between 50 and 300 μm.

30-41. (canceled)

42. The electrochemical converter according to claim 21 wherein the porous substrate of said strip comprises woven or nonwoven fabric.

43. The electrochemical converter according to claim 21 wherein the polymer base of said strip is chosen from at least one of a polyamide, polyester, or aramid base.

44. The electrochemical converter according to claim 21 wherein a thickness of the substrate of said strip is between 100 and 600 μm.

45. The electrochemical converter according to claim 21 wherein a density of the substrate of said strip is between 50 and 200 g/m².

46. The electrochemical converter according to claim 21 wherein metallization of the substrate of said strip is performed with Cu, Au, Sn, Ni, or NiP or an alloy of Cu, Au, Sn, Ni, or NiP.

47. The electrochemical converter according to claim 46 having a metallization deposit with a thickness between 0.5 and 20.

48. The electrochemical converter according to claim 46 wherein the substrate has a surface density of metallization between 25 and 300 g/m².

49. The electrochemical converter according to claim 21 wherein the material of the hydrophobic coating of said strip is a material that deposits at a temperature below 180° C.

50. The electrochemical converter according to claim 21 wherein the polymer of the hydrophobic coating of said strip is chosen among poly(Styrene-Ethylene-Butadiene-Styrene) (SEBS), poly(Styrene-Butadiene-Styrene) (SBS), poly(Styrene-Ethylene-Propylene-Styrene) (SEPS), homopolymer poly(butadiene)hydroxy (PBu), poly(Butadiene-Octene) (PBO), poly(Ethylene-Octene) (PEO), poly(Butadiene-Propylene) (PBP), poly(Vinylidene Difluoride) (PVDF), the poly(Vinylidene Difluoride (PVDF)-HexaFluoroPropylene (HFP)) copolymer or poly(vinylidene difluoride-co-trifluoroethylene) (PVDF-TrFE) or maleic anhydride grafted poly(Styrene-Ethylene-Butadiene-Styrene) (SEBS).

51. The electrochemical converter according to claim 21 wherein the porous conductive material of said strip is chosen from carbon black nanopowders, carbon nanofibers and carbon nanotubes.

52. The electrochemical converter according to claim 51 wherein the polymer/carbon ratio is between 10/90 and 50/50.

53. The electrochemical converter according to claim 51, wherein the strip has a polymer/carbon loading of between 5 and 50% by mass.
